(19) United States
(12) Patent Application Publication
(10) Pub. No.: US 2007/0147071 A1
(43) Pub. Date: Jun. 28, 2007

(54) Backlight module having switchable light sources and liquid crystal display using the same

(75) Inventors: Yu-Ju Hsu, Miao-Li (TW); Ko-Wei Chien, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,143

(22) Filed: Dec. 20, 2006

(30) Foreign Application Priority Data
Dec. 23, 2005 (TW) 94146364

(51) Int. Cl. F21V 7/04

(52) U.S. Cl. 362/601

(57) ABSTRACT

An exemplary liquid crystal display device (10) includes a liquid crystal display panel (11), and a backlight module (12) having two sets of light sources (18, 19) for illuminating the liquid crystal display panel. One set of light sources is a multicolor mixed light source, and the other set of light sources is white light source.

### FIELD OF THE INVENTION

The present invention relates to a backlight module having a switchable light source and a liquid crystal display employee the backlight module.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

In a conventional LCD device, red, green, and blue LEDs (light emitting diodes) are used as a multicolor mixed light source to ensure the LCD device employing them having a high color saturation. However, an irradiation efficiency of LEDs is greatly less than the cold cathode fluorescent lamp (CCFL). Therefore, a large number of LEDs are needed to arrange in the LCD device for ensuring the LCD device has a high brightness, which makes the LCD device unduly weighty and bulky.

It is desired to provide an LCD device which can overcome the above-described deficiencies.

### SUMMARY

An exemplary backlight module includes two sets of light sources. One set of light sources is a multicolor mixed light source, and the other set of light sources is white light source.

An exemplary liquid crystal display device includes a liquid crystal display panel, and a backlight module having two sets of light sources for illuminating the liquid crystal display panel. One set of light sources is a multicolor mixed light source, and the other set of light sources is white light source.

Other advantages and novel features will become more apparent from the following detailed description when taken in conjunction with the accompanying drawings.

### BRIEF DESCRIPTION OF THE DRAWINGS

FIG. 1 is a schematic, side view of an LCD device according to a first embodiment of the present invention.

FIG. 2 is a schematic, side view of an LCD device according to a second embodiment of the present invention.

FIG. 3 is schematic, side view of an LCD device according to a third embodiment of the present invention.

FIG. 4 is a schematic, top view of light sources and a reflective plate of the LCD device of FIG. 3.

### DETAILED DESCRIPTION OF PREFERRED EMBODIMENTS

Referring to FIG. 1, a schematic, side view of an LCD device according to a first embodiment of the present invention. The LCD device 10 includes an LCD panel 11, and a backlight module 12 disposed at a rear side of the LCD panel 11.

The backlight module 12 includes a prism sheet 13, a diffusion sheet 14, a first light guide plate 15, a second light guide plate 16, a reflective plate 17, a first light source 18, and a second light source 19. The prism sheet 13, the diffusion sheet 14, the first light guide plate 15, the second light guide plate 16, and the reflective plate 17 are disposed form top to bottom in that order. The first light source 18 is arranged adjacent to a side of the first light guide plate 15, and the second light source 19 is arranged adjacent to a side of the second light guide plate 16.

The first light guide plate 15 and the first light source 18 cooperate with each other to form the first set of light source. The light guide plate 15 includes a light incident surface 151 and a light output surface 152, and the first light source 18 is disposed adjacent to the light incident surface 151. When the first light source 18 is turned on, light beams emitted from the first light source 18 directly propagate within the light guide plate 15. Part of the light beams emits from the light output surface 152 directly, and another part of the light beams are transmitted to the reflective plate 17 via the second light guide plate 16, and then reflected by the light reflective plate 17, and are emitted out of the light output surface 152 via the second and the first light guide plates 16 and 15. After that, almost all the light beams emitted from the first light source 18 are refracted and concentrated by the diffusion sheet 14 and the prism sheet 13 before illuminating the LCD panel 11.

The first light source 18 is a CCFL (cold cathode fluorescent lamp), which is a normal white light source. The white light beams emitted by the CCFL are generated via exciting the fluorescent powder by electrons. This technology is mature, and an irradiation efficiency of the CCFL is greatly larger than the multicolor mixed light source.

The second light guide plate 16 and the second light source 19 cooperate with each other to form the second set of light source. The light guide plate 16 includes a light incident surface 161 and a light output surface 162, and the second light source 19 is disposed adjacent to the light incident surface 161. When the second light source 19 is turned on, light beams emitted from the second light source 19 directly propagate within the light guide plate 16. Part of the light beams emits from the light output surface 162 directly, and another part of the light beams are reflected by the light reflective plate 17 before emitting out of the light output surface 162. After that, almost all the light beams emitted from the first light source 19 passes the first light guide plate 15, and are refracted and concentrated by the diffusion sheet 14 and the prism sheet 13 before illuminating the LCD panel 11.

The second light source 19 includes a plurality of multicolor mixed light sources, each of which includes four LEDs encapsulated in a housing. The four LEDs are a red LED, two green LEDs, and a blue LED. Each multicolor mixed light source emits white light beams mixed by the colored light beams emitted by the red, green, blue LEDs. This kind of white light beams has high color saturation.

The first and second sets of light sources can individually or cooperatively illuminate the LCD panel 11. When the LCD device 10 is in a text processing mode, it can only turn on the first light source 18 to illuminate the LCD panel 11. The first light source 18 has high irradiation efficiency, and only turning on the first light source 18 can lower the power consumption of the LCD device 10. When the LCD device 10 is in a multimedia processing mode, it can turn off the first light source 18 and turn on the second light source 19, so as to illuminate the LCD panel 11. The second light source 19 has a high color saturation, which can ensure the LCD device 10 meet with the requirement of display multimedia images. When the LCD device is in a multimedia processing mode and needs high brightness, the first and second light sources 18 and 19 are both turned on to illuminate the LCD panel 11. This illuminating mode is adapted to use in indoor environment having power supply.

With these configuration, the backlight module 12 includes two sets of light sources, which are switchable according to different operation modes. Various modifications and alterations are possible within the ambit of the invention herein. The LEDs of the second light source 19 are not limited to four LEDs encapsulated, it can be three LEDs encapsulated, or six LEDs encapsulated. The second light source 19 may be a plurality of lamps emitting color light beams.

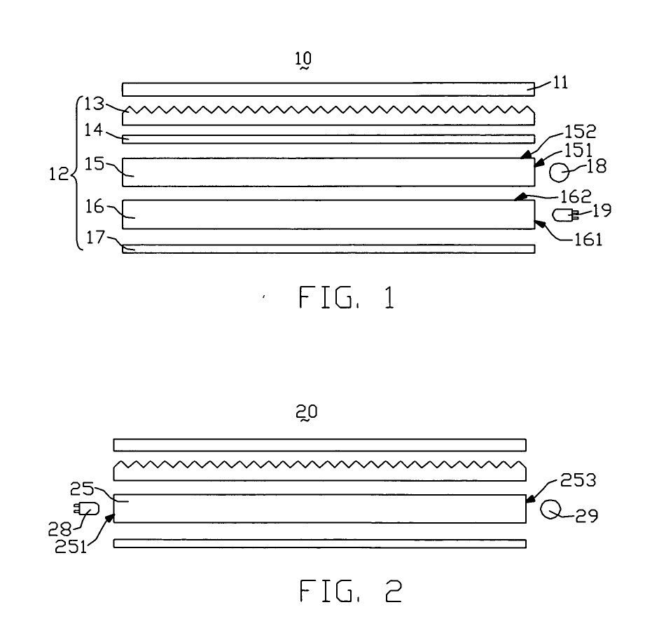

Referring to FIG. 2, a schematic, side view of an LCD device according to a second embodiment of the present invention is shown. The LCD device 20 has a structure similar to that of the LCD device 10. However, The LCD device 20 includes only a light guide plate 25 having two opposite light incident surfaces 251 and 253. The first light source 28 is disposed adjacent to the light incident surface 251, and the second light source 29 is disposed adjacent to the light incident surface 253. The first light source 28 includes a plurality of white LEDs, and the second light source 29 includes a plurality of lamps emitting colored light beams so as to form a multicolor mixed light source. The first and second light sources 28 and 29 are switchable.

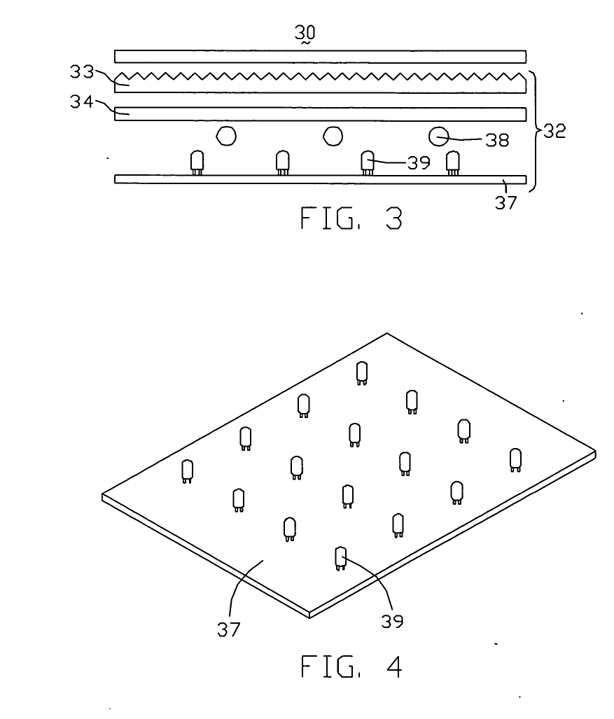

Referring to FIG. 3, a schematic, side view of an LCD device according to a third embodiment of the present invention is shown. The LCD device 30 has a structure similar to that of the LCD device 10. However, The LCD device 30 includes a direct type backlight module 32. The backlight module 32 includes a prism sheet 33, a diffusion sheet 34, a first light source 38, a second light source 39, and a reflective plate 37 disposed from top to bottom in that order.

The first light source 38 includes a plurality of CCFLs parallel disposed, which are white light sources. The second light source 39 includes a plurality of LEDs arranged in an array type (shown in FIG. 4). Each of the LEDs is four LED encapsulated. The first and second light sources 28 and 29 are alternatively disposed between the reflective plate 37 and the diffusion sheet 34.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising two sets of light sources;
wherein one set of light sources is a multicolor mixed light source, the other set of light sources is white light source.

2. The backlight module as claimed in claim 1, wherein the two sets of light sources are a first and a second set of light sources, the first set of light source is white light source, and the second set of light source is multicolor mixed light source.

3. The backlight module as claimed in claim 2, wherein the first set of light source includes a first light guide plate and a cold cathode fluorescent lamp disposed adjacent thereto, the second set of light source includes a second light guide plate and at least one light emitting diode disposed adjacent thereto.

4. The backlight module as claimed in claim 3, wherein the light emitting diode includes four sub-LEDs encapsulated together, which are a red LED, two green LEDs, and a blue LED.

5. The backlight module as claimed in claim 2, further comprising a light guide plate having two opposite light incident surfaces, and the first and second sets of light source are disposed adjacent to the two light incident surfaces of the light guide plate, respectively.

6. The backlight module as claimed in claim 2, further comprising a diffusion sheet and a reflective plate, the first and second sets of light sources are disposed between the diffusion sheet and the reflective plate.

7. The backlight module as claimed in claim 6, wherein the first set of light source includes a plurality of cold cathode fluorescent lamps parallel disposed, and the second set of the light source includes a plurality of LEDs disposed in an array type under the first set of light source.

8. A liquid crystal display device, comprising:
a liquid crystal display panel;
a backlight module having two sets of light sources for illuminating the liquid crystal display panel;
wherein one set of light sources is a multicolor mixed light source, the other set of light sources is white light source.

9. The liquid crystal display as claimed in claim 8, wherein the two sets of light sources are a first and a second set of light sources, the first set of light source is white light source, and the second set of light source is multicolor mixed light source.

10. The liquid crystal display as claimed in claim 9, wherein the first set of light source includes a first light guide plate and a cold cathode fluorescent lamp disposed adjacent thereto, the second set of light source includes a second light guide plate and at least one light emitting diode disposed adjacent thereto.

11. The liquid crystal display as claimed in claim 10, wherein the light emitting diode includes four sub-LEDs encapsulated together, which are a red LED, two green LEDs, and a blue LED.

12. The liquid crystal display as claimed in claim 9, further comprising a light guide plate having two opposite light incident surfaces, and the first and second sets of light source are disposed adjacent to the two light incident surfaces of the light guide plate, respectively.

13. The liquid crystal display as claimed in claim 9, further comprising a diffusion sheet and a reflective plate, the first and second sets of light sources are disposed between the diffusion sheet and the reflective plate.

14. The liquid crystal display as claimed in claim 13, wherein the first set of light source includes a plurality of cold cathode fluorescent lamps parallel disposed, and the second set of the light source includes a plurality of LEDs disposed in an array type under the first set of light source.

15. A backlight module comprising two sets of light sources;
wherein one set of light sources is of points arrangement, the other set of light sources is of tubes arrangement.

16. The backlight module as claimed in claim 15, further including two light guide plates confronting the corresponding sets of light sources, respectively.
